(19) United States
(12) Patent Application Publication
(10) Pub. No.: US 2011/0199942 A1
(43) Pub. Date: Aug. 18, 2011

(54) METHOD AND SYSTEM FOR REALIZING EMERGENCY CALLING SERVICE IN HIGH RATE PACKET DATA NETWORK

(75) Inventors: Xiaowu Zhao, Shenzhen City (CN); Kexue Lu, Shenzhen City (CN)

(73) Assignee: ZTE CORPORATION, Shenzhen City, Guangdong Province (CN)

(21) Appl. No.: 13/125,931

(22) PCT Filed: Sep. 24, 2009
(86) PCT No.: PCT/CN2009/074173

§ 371 Date: Apr. 25, 2011

(30) Foreign Application Priority Data
Oct. 27, 2008 (CN) 200810172538.5

(51) Int. Cl. H04L 12/16

(52) U.S. Cl. 370/259

(57) ABSTRACT

The present invention discloses a method and system for providing an emergency calling service for a high speed packet data network based on the CDMA technology. An access network transmits an emergency calling indication carried in an emergency calling message which is initiated by an access terminal to a packet data service node such that the emergency calling service can be implemented under the support of the packet data serving node.

### TECHNICAL FIELD

The present invention relates to a high speed packet data network in the field of CDMA, and more particularly, to a method and system for implementing an emergency calling service in the high speed packet data network.

### TECHNICAL BACKGROUND

CDMA2000 high speed packet data network (HRPD) is a CDMA technology based network which is devoted to provide high speed packet data services. With the development of air interface technology, HRPD Rev A is able to provide data services with a forward rate of 3.1 Mbps and a backward rate of 2.1 Mbps under a bandwidth of 1.25 MHz. This ensures that real-time services, such as VoIP based voice services, in a11-IP networks, may be more widely used. The a11-IP networks are better than the traditional circuit domain based CDMA20001x network in terms of the cost of network layout of operators and the providing of richness and betimes of services.

Emergency calling service, which is a special service, provides emergency help for demanders who have special requirements, even in relation to life and safety. The emergency calling service, to which attention is paid by every government in the world, requires that the operators should provide such service in any of their wireless networks. Therefore, providing the emergency calling service in the a11-IP networks has become a research hotspot.

The CDMA technology based high speed packet data network (HRPD), which is one of the a11-IP networks, is studying the providing of the VoIP based emergency call as well. For example, in a HRPD air interface version Rev B, when a user initiates an emergency calling service and a bearer network connection is established or the emergency calling service is triggered in a connection state, emergency calling indications carried in a ConnectRequest message and a ReservationOnRequest message respectively are sent to a radio access network (RAN) such that the RAN takes the related processing mechanism, such as simplification of access authentication and guarantee of resource allocation.

For example, FIG. 1 is a structural model of a bearer access network of the HRPD network (in which a SC/MM function is located in the access network (AN)), wherein the VoIP-based emergency calling service is established in an IP application layer which is an upper layer of the network (which holds true for a network model in which the SC/MM function is located in a packet control function (PCF)).

The access network (AN) is a logic entity used to communicate with an access terminal (AT) in the radio access network (RAN). The AN is equivalent to a base station (BS) in a 1x system.

The access terminal is a device providing data connection for the user. The access terminal may be connected to a calculation device, such as a personal computer, or acts as an independent data device, such as PDA (personal digital assistant). The access terminal is equivalent to a mobile station in the 1x system.

AN-AAA is an entity performing access authentication and authorization function for the RAN.

The PCF is an entity in the radio access network and is used to manage relaying of data between the AN and a packet data serving node (PDSN).

The PDSN is an entity used to send packet data services initiated or terminated by the AT. The PDSN is able to establish, maintain and terminate its link layer session with the AT.

The SC/MM (session control and mobility management) function is located in the AN logically, or it may be located in the PCF as well. It is responsible for management of radio access authentication and related mobility of the AT.

It should be noted that the PDSN plays a very important role and is a point for connecting the HRPD network which bears services with upper layer application services, that is, PCRF (Policy & Charging Rule Function) connection for the PDSN and an IMS platform, to perform some special policies of the operators' networks. Additionally, for a prepaid situation, the PDSN also acts as a prepaid client and is connected to a Radius server in a visited network and is connected to a Radius server/prepaid server in its home network through an IP network as well.

The emergency calling service is a end-to-end service, and when an air interface of the HRPD supports this service, the AT is required to carry the corresponding emergency calling indication to send the AN of the RAN. However, it is not determined whether the RAN is required to transmit the emergency calling indication to the PDSN and how the RAN transmits the emergency calling indication to the PDSN or how the PDSN responds after receiving the emergency calling indication.

### SUMMARY OF THE INVENTION

A technical problem to be solved by the present invention is to provide a method and system for implementing an emergency calling service in a high speed packet data network such that the emergency calling service can be implemented under support of a packet data service node.

In order to solve the above-described problem, the present invention provides a method for implementing an emergency calling service in a high speed packet data network comprising:

(a) an access terminal and an access network configuring an IP flow for supporting the emergency calling service;

(b) the access network sending a first connection request to a packet control function, the first connection request carrying an emergency calling indication;

(c) the packet control function sending a second connection request to a packet data service node after receiving the first connection request, the second connection request carrying an emergency calling indication; and

(d) the packet data service node establishing a connection based on the emergency calling indication in the received second connection request to implement the emergency calling service.

Further, the step (a) comprises the access terminal sending a third connection request to the access network to trigger the access terminal and the access network to configure the IP flow, the third connection request carrying an emergency calling indication.

Further, in the step (a), the third connection request is a connection establishment request message or a resource reservation request message such that an emergency calling connection is established between the access terminal and the access network for the first time or an emergency calling service connection is added to existing connections.

Further, the step (d) comprises the packet data service node directly establishing a connection based on the received emergency calling indication irrespective of whether the access terminal owes or whether the access terminal establishes a connection directly for a legal authentication terminal.

Further, in the step (d), the establishing the connection comprises establishing first a connection between the packet control function and the packet data service node and then establishing a connection between the access network and the packet control function.

Further, the step (d) comprises the packet data service node performing corresponding processing according to operators' strategy in addition to establishing the connection.

Further, the emergency calling service refers to a high priority service or a level of priority service in priority services.

In order to solve the above-described technical problem, the present invention also provides a system for implementing an emergency calling service in a high speed packet data network, which comprises an access terminal, an access network, a packet control function and a packet data serving node.

The access terminal is configured to configure an IP flow for supporting the emergency calling service.

The access network is configured to receive a request sent by the access terminal in configuring the IP flow and configure the IP flow, and is further configured to send a first connection request to the packet control function, the first connection request carrying an emergency calling indication.

The packet control function is configured to receive the first connection request sent by the access network and establish a connection, and is further configured to send a second connection request to the packet data serving node, the second connection request carrying an emergency calling indication.

The packet data serving node is configured to receive the second connection request sent by the packet control function and establish a connection.

Further, the access terminal is also configured to send a third connection request to the access network, the third connection request being a connection establishment request message or a resource reservation request message sent by the access terminal according to air interface establishment situations, and the request message carrying an emergency calling indication, to establish a connection for the first time or add an emergency calling service connection to existing connections.

Further, the emergency calling service refers to a high priority service or a level of priority service in priority services.

The method and system in accordance with the present invention provides the emergency calling service for the high speed packet data network based on the CDMA technology, and the RAN transmits the emergency calling indication carried in the emergency calling message which is initiated by the AT to the PDSN such that the emergency calling service can be implemented under the support of the packet data serving node, improving the emergency calling service, especially the processing mechanism on the network side, thereby further satisfying the wide application of the service in the existing network.

### BRIEF DESCRIPTION OF DRAWINGS

FIG. 1 is a block diagram of an access network of an HRPD network;

FIG. 2 is a flow chart of a method for implementing an emergency calling service in a high speed packet data network in accordance with the present invention; and

FIG. 3 is a schematic diagram of an application embodiment of the method for implementing the emergency calling service in accordance with the present invention.

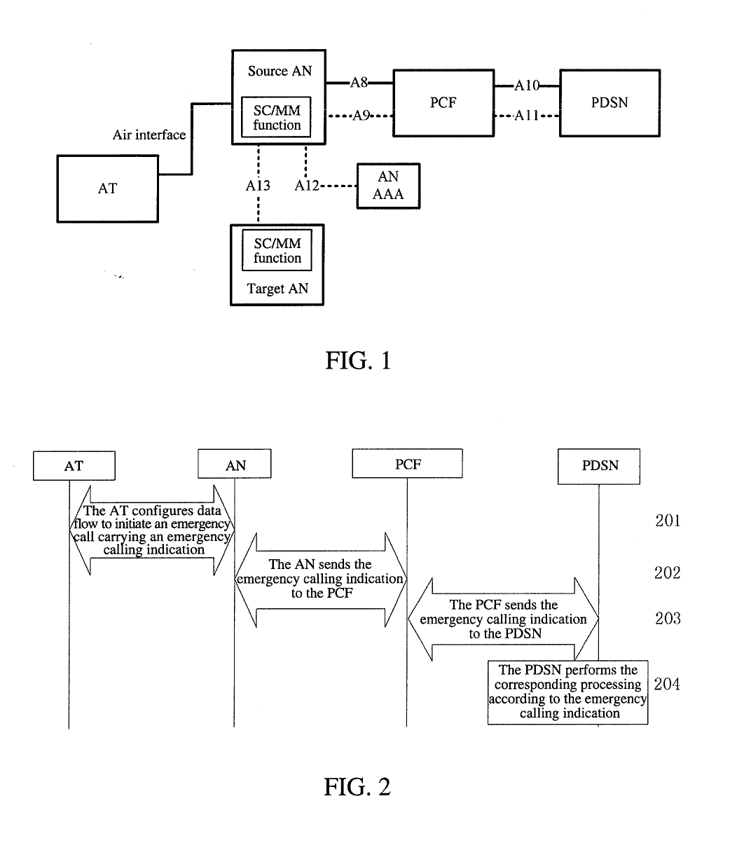

### PREFERRED EMBODIMENTS OF THE PRESENT INVENTION

A method for implementing an emergency calling service in a high speed packet data network is shown in FIG. 2 and comprises the following steps.

Step 201, an access terminal configures an IP data flow to initiate an emergency calling.

The configuration of such data flow may be based on the access terminal and be triggered after the access terminal sends a connection request to an access network, with the request carrying an emergency calling indication, to ensure the AN's preferential allocation for its resource.

The access terminal inputs an address of the emergency call (TEL RUL) into an IP network to initiate the emergency call. Since this emergency call relates to two portions, an application layer and a bearer network, the present invention mainly focuses on the bearer network, that is, the basic HRPD, and the emergency calling service requires that the bearer network HRPD firstly ensure that the access terminal initiates the emergency call in a connection state.

The access terminal knows that a user is initiating an emergency call by analyzing the TEL RUL and sends different connection request messages according to whether there is an air interface. If an air interface connection is not established previously, the access terminal sends a ConnectionRequest message to the access network to establish an emergency calling service connection for the first time, with the request carrying an emergency calling indication; if the AT determines that there already has been the air interface connection in the connection state, the access terminal sends a ReservationOnRequest message to the access network to add the emergency calling service connection to existing connections, with the request carrying an emergency calling indication.

Step 202, the access network sends a connection request to the packet control function (PCF) to establish an A8/10 connection required for the emergency calling service or to add the emergency calling service connection to the existing connections, with the request carrying an emergency calling indication.

There are two interfaces, a signaling interface A9 and a packet transfer interface A8, between the AN and the PCF. Since the establishment of the interface A8 needs signaling control of the interface A9, using the A9-establishment-A8 message, a message for establishing the A8 connection is sent at the interface A9 to trigger the establishment of the A10 and A8 connections, so as to ensure that the packets can be transferred between the AT and the PDSN.

Step 203, the packet control function sends a connection request to the packet data serving node to establish the A10 connection required for the emergency calling service or to add the emergency calling service connection to the existing connections, with the request carrying an emergency calling indication.

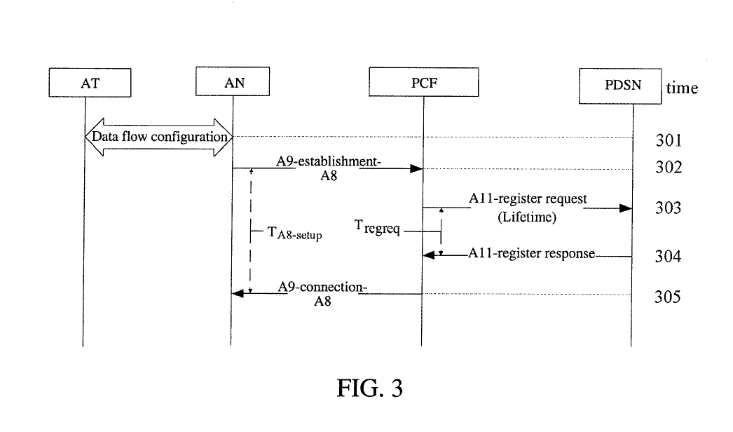

The above-mentioned connection request is an A11-register request message, as shown in FIG. 3.

Step 204, the packet data serving node (PDSN) performs the corresponding processing according to the emergency calling indication to implement the emergency calling service.

The packet data serving node performing the corresponding processing according to the emergency calling indication comprises:

ensuring the corresponding A10 resource between the PCF and the PDSN and establishing the corresponding A10 connection, and when establishing the connection, firstly establishing a connection between the packet control function and the packet Data serving node, and then establishing a connection between the access network and the packet control function.

According to feedback from a prepaid server, the PDSN can guarantee the corresponding A10 connection and the establishment of the emergency calling service, even for owing users.

When the PDSN negotiates with a PPP associated with an AAA, the negotiation process may be compressed, such as, skipping the ACCM negotiation.

For legal users, when the PDSN sends a charging message to the AAA, it exempts the charging message according to the operators' strategy.

The PDSN may perform the corresponding processing according to any other behaviors related to the emergency calling service specified by the PRCF.

The emergency calling service described in the present invention may be the emergency calling service in a general sense of a11-IP networks, or it may be a high priority service or a level of priority service in priority services specified by the user according to the protocol.

In order to implement the above method, a system for implementing an emergency calling service in a high speed packet network in accordance with the present invention comprises an access terminal (AT), an access network (AN), a packet control function (PCF) and a packet data serving node (PDSN).

The access terminal is configured to send a connection request to the access network and configure an IP flow, with the request carrying an emergency calling indication.

The access terminal sends a ConnectionRequest message or a ReservationOnRequest message to the access network according to air interface establishment situations to establish a connection for the first time or reserve new service resource on the basis of the existing connections.

The access network is configured to receive the request from the access terminal and establish the connection, and is further configured to send the connection request to the packet control function, with the request carrying an emergency calling indication.

The packet control function, which is an entity in a radio access network, is configured to receive the request from the access network and establish the connection, and is further configured to send the connection request to the packet data serving node, with the request carrying an emergency calling indication.

The access network and the packet control function are further configured to setup a timer, and turn on the timer after sending the connection request and turn off the timer after receiving a response to the connection request. An initiator may resend the request if the response to the request response is not received before timeout of the timer.

The packet data serving node is configured to receive the request from the packet control function and establish the connection.

The establishing the connection comprises establishing the connection for the first time and adding an emergency calling service connection to the existing connections. All of the connections are bearer packet interface connections, while a signaling interface connection is a connection which exists naturally during network configuration.

When the connections is established, the connection between the packet control function and the packet data serving node is established first, and then the connection between the access network and the packet control function is established.

Of course, the system also comprises a prepaid server and an AAA server such that the packet data serving node perform message interaction therewith and know information, such as payment of the access terminal. However, no matter whether the access terminal owes or whether the access terminal is legal, because the service initiated by the access terminal is the emergency calling service, the packet data service node will ensure the establishment of the connection and perform the corresponding processing, such as exempting charging information, according to the operators' strategy.

The method in accordance with the present invention will be described through an application embodiment below.

A terminal user, who is a prepaid user, is in an arrearage state. However, when the terminal user encounters the emergency calling service, he/she will initiate the emergency calling service. As shown in FIG. 3, the application process will be described as follows.

Step 301: the AT and the AN configure session for an IP flow, and the AN maps a new IP flow or re-activates the IP flow in a new service connection. If the configuration of the flow is for the emergency calling service, or the AT receives the SIP (Session Initiation Protocol) signaling from the network to initiate the emergency calling service, it provides an emergency calling indication in a subsequent A9/A11 message to the PDSN.

The emergency call initiated after the SIP signaling is received from the network is a triggering message of the emergency call initiated by an emergency calling center for the activated user. By activation is meant that both the AT and the AN are in a connection state, for example, the user is online.

Step 302, if the AN determines that it has not established an A8/A10 connection, or the current A8/A10 connection is not sufficient to support the emergency calling and a new A8/A10 connection is required, the AN sends a A9-establishment-A8 message to the PCF to trigger the establishment of the A8 and A10 connections and start up the timer T_{A8-setup} to monitor response duration.

The A9-establishment-A8 message contains an A8 service ID of the corresponding primary service connection and an additional A8 service ID of the corresponding secondary A8 connection and carries an emergency calling indication.

The primary connection is the connection established for the first time and is mainly used to establish a PPP connection between the AT and the PDSN and to transfer authentication data. The secondary connection means that a new connection is required to be added to transfer IP packets when the primary connection cannot satisfy service requirements. One VOIP service generally has a control flow and an audio flow, both of which may be transferred over one A8/A10 connection or different A8/A10 connections.

The A9-establishment-A8 message contains all A8 connections required to be remapped, including the connections that have been established and are to be established. The A8 connection to be released is not contained in the A9-establishment-A8 message.

Step 303, the PCF sends an A11-register request message to the PDSN to trigger the establishment of the A10 connection and start up a timer T_{regreq}.

The PCF comprises all information of the A10 connection corresponding to the A8 connection received in the step 302. The A11-register request message contains session specific extension IE corresponding to the primary connection, additional session information corresponding to the secondary connection in the NVSEs, and the emergency calling indication.

Step 304, although the PDSN knows that the user owes according to a prepaid server, it establishes a new A10 connection for the user due to receipt of the emergency calling indication, and sends an A11-register response message to the PCF and stops the timer T_{regreq} after receiving the response message.

The A11-register response message contains the session specific extension IE corresponding to the primary connection and the additional session information corresponding to the secondary connection in the NVSEs. The PDSN comprises the information of the A10 connection received in the step 303.

If there has been a connection previously, because the IP flow is reconfigured in the case where an emergency call is initiated via the air interface such that some A8/A10 connections that possibly exist are not necessary, then the PDSN and the PCF release those A10 connections which do not contain the related information in the message.

Step 305, the PCF establishes a new A8 connection and sends an A9-connection-A8 message to the AN, which stops the timer T_{A8-setup}.

The A9-connection-A8 message contains the A8 service ID corresponding to the primary connection and the additional A8 service ID corresponding to the secondary A8 connection. The A9-connection-A8 message contains the information of all A8 connections received in the step 302. The PCF and the AN release the A8 connections which do not contain the related information in the message.

The method and system in accordance with the present invention provides the emergency calling service for the high speed packet data network based on the CDMA technology, and the RAN transmits the emergency calling indication carried in the emergency calling message which is initiated by the AT to the PDSN such that the emergency calling service can be implemented under the support of the packet data serving node, improving the emergency calling service, especially the processing mechanism on the network side, thereby further satisfying the wide application of the service in the existing network.

### INDUSTRIAL APPLICABILITY

The method and system in accordance with the present invention provides the emergency calling service for the high speed packet data network based on the CDMA technology, and the RAN transmits the emergency calling indication carried in the emergency calling message which is initiated by the AT to the PDSN such that the emergency calling service can be implemented under the support of the packet data serving node, improving the emergency calling service, especially the processing mechanism on the network side, thereby further satisfying the wide application of the service in the existing network.

1. A method for implementing an emergency calling service in a high speed packet data network comprising:
(a) an access terminal and an access network configuring an IP flow for supporting the emergency calling service;
(b) the access network sending a first connection request to a packet control function, the first connection request carrying an emergency calling indication;
(c) the packet control function sending a second connection request to a packet data service node after receiving the first connection request, the second connection request carrying an emergency calling indication; and
(d) the packet data service node establishing a connection based on the emergency calling indication in the received second connection request to implement the emergency calling service.

2. The method according to claim 1, wherein the step (a) comprises the access terminal sending a third connection request to the access network to trigger the access terminal and the access network to configure the IP flow, the third connection request carrying an emergency calling indication.

3. The method according to claim 2, wherein in the step (a), the third connection request is a connection establishment request message or a resource reservation request message such that an emergency calling connection is established between the access terminal and the access network for the first time or an emergency calling service connection is added to existing connections.

4. The method according to claim 1, wherein the step (d) comprises the packet data service node directly establishing a connection based on the received emergency calling indication irrespective of whether the access terminal owes or whether the access terminal establishes a connection directly for a legal authentication terminal.

5. The method according to claim 1, wherein in the step (d), the establishing the connection comprises establishing first a connection between the packet control function and the packet data service node and then establishing a connection between the access network and the packet control function.

6. The method according to claim 1, wherein the step (d) comprises the packet data service node performing corresponding processing according to operators' strategy in addition to establishing the connection.

7. The method according to claim 1, wherein the emergency calling service refers to a high priority service or a level of priority service in priority services.

8. A system for implementing an emergency calling service in a high speed packet data network comprising an access terminal, an access network, a packet control function and a packet data serving node, wherein
the access terminal is configured to configure an IP flow for supporting the emergency calling service;
the access network is configured to receive a request sent by the access terminal in configuring the IP flow and configure the IP flow, and is further configured to send a first connection request to the packet control function, the first connection request carrying an emergency calling indication;
the packet control function is configured to receive the first connection request sent by the access network and establish a connection, and is further configured to send a second connection request to the packet data serving node, the second connection request carrying an emergency calling indication; and
the packet data serving node is configured to receive the second connection request sent by the packet control function and establish a connection.

9. The system according to claim 8, wherein the access terminal is further configured to send a third connection request to the access network, the third connection request being a connection establishment request message or a resource reservation request message sent by the access terminal according to air interface establishment situations, and the request message carrying an emergency calling indication, to establish a connection for the first time or add an emergency calling service connection to existing connections.

10. The system according to claim 8, wherein the emergency calling service refers to a high priority service or a level of priority service in priority services.

11. The method according to claim 2, wherein the emergency calling service refers to a high priority service or a level of priority service in priority services.

12. The method according to claim 3, wherein the emergency calling service refers to a high priority service or a level of priority service in priority services.

13. The method according to claim 4, wherein the emergency calling service refers to a high priority service or a level of priority service in priority services.

14. The method according to claim 5, wherein the emergency calling service refers to a high priority service or a level of priority service in priority services.

15. The method according to claim 6, wherein the emergency calling service refers to a high priority service or a level of priority service in priority services.
